(19) United States
(12) Patent Application Publication
(10) Pub. No.: US 2003/0059117 A1
(43) Pub. Date: Mar. 27, 2003

(54) Systems and methods for image processing, and recording medium therefor

(75) Inventors: Katsuhiro Iwasa, Iizuka-Shi (JP); Hideaki Matsuo, Fukuoka-Shi (JP); Yuji Takata, Yokohama-Shi (JP); Kazuyuki Imagawa, Fukuoka-Shi (JP); Eiji Fukumiya, Iizuka-Shi (JP)

Correspondence Address: DARBY & DARBY P.C., P. O. BOX 5257, NEW YORK, NY, 10150-5257, US

(73) Assignee: Matsushita Electric Industrial Co., Ltd.

(21) Appl. No.: 10/256,213

(22) Filed: Sep. 26, 2002

(30) Foreign Application Priority Data
Sep. 27, 2001 (JP) 2001-296830

(51) Int. Cl. G06K 9/46; G06K 9/66; G06K 9/62

(52) U.S. Cl. 382/224; 382/190; 382/209

(57) ABSTRACT

An image processing device has an edge extraction unit, which inputs an image and generates an edge image, a voting unit, which uses templates to carry out voting on the edge image and generate voting results; a maxima extraction unit, which extracts the maxima among the voting results and generates extraction results; and an object identifying unit, which identifies the position of an object based on the extraction results. The edge extraction unit has a filter processing unit that uses a filter for performing simultaneous noise elimination and edge extraction of the image.

### BACKGROUND OF THE INVENTION

1. Field of the Invention

The present invention is directed to image processing and, more particularly, to systems and methods for automatically detecting the position, location, and the like, of an object in an input image at a high level of speed and with a high degree of accuracy.

2. Description of the Related Art

A person's face possesses important significance for expressing their thoughts and emotions. The iris within the person's pupil can be used as an index for identifying who the person is. Therefore, in the field of image processing it is convenient to automatically process the position and size of an object within an image when the image (e.g., a still image, a moving image, computer graphics, or the like) contains a face, a pupil, or some other object. Others in the field are endeavoring to develop systems that provide the convenience of extracting objects obtained from images.

There are methods that use Hough transformation to extract faces from images. One such method is described in “‘Head Finder: Person Tracing Based on Inter-frame Differences’, Image Sensing Symposium 2000, pp. 329-334.” (Hereafter, the “Head Finder” reference)

Here, a system is disclosed in which a face is approximated as a single circle and the face is then extracted using templates having a plurality of concentric circles of different sizes. In addition, different voting planes are generated based on the respective radii of the concentric circles.

Using these templates, raster scanning is performed on an image. Here, if the center of a template overlaps with an edge point (i.e., a point on a contour), the addition of a fixed value (i.e., voting) is then performed on the points comprising the circle in each voting plane.

Upon completion of a raster scan, the position of a point with the greatest vote value is assigned to the position of the face, and the size of the circle of the voting plane to which the assigned point belongs is designated as the size of the face.

Given a plurality of faces, the detection of the positions and sizes of all of the faces by a single raster scan is thereby enabled even when an image contains a plurality of faces of various sizes.

Japanese Unexamined Patent Publication No. Hei 4-225478 discloses a method for determining the position of the central portion of an eye. Here, edges are detected from an image, and an arc is formed using the radius of curvature of a segment of an edge. The center of the iris of the eye is found by determining the point at which the largest number of such arcs intersect and designating this point as the center of the iris.

Generally when objects are detected in the manner set forth in Hei 4-225478 reference, there is a trade off between the processing speed and the precision in which objects are extracted. That is, the load on a processor must increase with time as an extraction process is made more resistant to fluctuations in the surrounding environment. Conversely, when the load on the processor is restricted, it becomes difficult to maintain the level of precision at which the objects are extracted, except in specific environments.

In the field of iris authentication, there is also a demand for a method for rapidly extracting objects from images because rapid automatic detections of a pupil from an image of the vicinity of an eye contributes greatly to a reduction in the processing time of a subsequent authentication process.

In the system disclosed in the Head Finder reference, the Hough transformation processing time is reduced by performing Hough voting for a batch of a plurality of different sized circles. However, this extraction method is based on inter-frame differences. Thus in the case where a person is motionless, the contour edges of the person cannot be detected from the difference in the person's movements. In addition, in environments where the background is moving, many edges are generated in the surrounding regions due to the differences of the movement, and among such edges the contour edges of a person will be masked. Thus in either case, edge detection is difficult and consequently, extraction of a face region is difficult.

In the method described in the Hei 4-225478 reference, when the conditions for obtaining an image of an eye region are poor, the edge image deteriorates and it becomes necessary to use a heavy amount of computational processing to detect arcs.

With reference to FIG. 16, a system is shown that was studied by the present inventors as an alternative to improve the system disclosed in the Head Finder reference. In this system, in place of the frame differences of Head Finder reference, edges are extracted by application of a Sobel filter in accordance to an ordinary still image edge detection method.

FIG. 16(a) is a graphical plot of the results of an edge extraction performed using a Sobel filter. As is clear from FIG. 16(a), although the primary edge points are detected (i.e., the contour 101 of a face and contour 102 of shoulders), numerous extraneous edge points 103 are also detected. These edge points 103 are simply noise.

Thus, if Hough voting is performed on the result of the edge extraction above, the results shown in FIG. 16(b) will be obtained. That is, circles centered around the noise (edge points 103) like templates t4 and t5, will be voted on, in addition to the face contour. As a result, the amount of computational processing necessary is increased and the precision of the voting results is reduced.

Regardless of whether or not the edge points are noise, if the number of edge points increases, the number of templates that are added will increase proportionately and the processing amount will increase exponentially. Thus, with a processing capability of a personal computer, a vast amount of processing time will be required and real time processing will be difficult.

Because the detection of characteristic points from voting planes requires an extremely large amount processing time and real time processing is difficult, using dispersion or sorting by a threshold value to achieve a higher speed may be considered. However, if culling or averaging according to unit block is performed to increase processing speed, the precision of extraction may be negatively affected. For example, a face position may become buried in noise or only noise may be extracted.

As further shown in FIG. 16(a), in order to eliminate edge points that are actually small noise, an edge image may be generated once, then that image may be compared with a previously set threshold value. Thereafter, Hough voting may be performed.

However, setting an appropriate threshold value is extremely difficult. Because the size, etc. of an object in an image cannot be known prior to the input of the image, experience must be used to set a suitable threshold value. Also, this threshold value dictates the strength of the noise elimination effect.

If the noise elimination effect is too weak, a large amount of noise will remain and the conditions may not differ much from those shown in FIG. 16(b). On the other hand, if the noise elimination effect is too strong, all or part of the face contour 101, which is important to preserve, may become lost or disappear. As a result the precision of the voting results will be reduced.

It is thus difficult to eliminate noise and preserve the contour of the face by performing noise elimination as described above because that method is dependent on the characteristics of each individual image.

Taking the above into consideration, the present inventors have devised a filter, and associated components, which can be applied regardless of the characteristics of an image and can consequently eliminate noise appropriately.

### SUMMARY OF THE INVENTION

The present invention is directed to systems and methods for extracting the position, location, and the like, of an object in an input image at a high level of speed and with a high degree of accuracy. In accordance with the present invention, an image processing device is used to accomplish the extraction of the image.

Here, the image processing device comprises: an edge extraction unit, which inputs an image and generates an edge image; a voting unit, which uses templates to perform voting on the edge image and generates voting results; a maxima extraction unit, which extracts the maxima among the voting results and generates extraction results; and an object identifying unit, which identifies the position of an object based on the extraction results.

In accordance with the invention, the edge extraction unit limits the number of detected edge points at a stage prior to the voting unit such that the number of extracted position candidates of an object are reduced at a high level of speed and a high level of precision by the maxima extraction unit at the subsequent stage. As a result, the position and size of the object can be extracted in real time from either a moving image or a still image.

In an aspect of the invention, the edge extraction unit is equipped with a filter processing unit, which comprises a filter that performs simultaneous noise elimination and edge extraction of the image. As a result, noise elimination and edge extraction can be completed by performing raster scanning of the filter just once. This permits the performance of edge extractions at a high level of speed while maintaining a high level of accuracy.

In accordance with an aspect of the invention, the edge extraction unit is equipped with a thinning unit, which thins the filter process results of the filter processing unit. Hence, the edges of the filter process results are sharp even when the edges are drawn with thick lines.

Here, the filter comprises a Gaussian filter and a unit vector. As a result, blurring effects cause by the Gaussian filter and the edge extraction effect that is caused by a unit vector can be exhibited simultaneously. That is, while noise is accurately eliminated, regardless of the characteristics of the image, only the necessary edges are routinely extracted.

In another aspect of the invention, the filter processing unit outputs filter process results and edge vectors within an x-y plane by using an x-direction filter and a y-direction filter. With this arrangement, by using a filter for the two x and y directions, it becomes possible to express the edges in the form of two-dimensional, x-y edge vectors.

In a further aspect of the invention, the thinning unit thins the filter process results based on the relationship between the magnitude of the filter process results for a target pixel and the magnitude of pixels adjacent to the target pixel, and by the directions of the edge vectors. Here, a simple magnitude comparison and the direction of the edges vectors is used to accurately perform thinning. The thinning may be performed even when the filter process results have edges that are drawn with thick lines.

In another aspect of the invention, the maxima extraction unit generates extraction results based on the differences between the voting result of a central pixel and the voting results of pixels in an area surrounding the central pixel. With this arrangement, the system searches for a point in the voting plane at which the absolute evaluation vote value is high relative to the vote values of the surrounding area. That is, the present aspect of the invention permits the detection of only a portion of the image for which not only is the vote value high but the vote value becomes rapidly high. In accordance with the present aspect of the invention, this is preferred when detecting a face region or eye region that exhibits a vote value having such characteristics.

In a further aspect of the invention, the maxima extraction unit uses a ring filter that determines the differences between the voting results of a central pixel and the voting results of pixels in the area surrounding the central pixel to generate extraction results. As a result, by simply using the raster scanning of the ring filter, it becomes possible to detect only the part of the image for which not only the vote value is high but the vote value changes rapidly.

In an additional aspect of the invention, templates, voting results, and extraction results are stored based on a classification of a plurality of sizes. Here, the object identifying unit identifies the position and size of an object. As a result, the size of the object as well as the position of an object may be detected simultaneously.

### BRIEF DESCRIPTION OF THE DRAWINGS

The above foregoing and other advantages and features of the present invention will become apparent from the following description read in conjunction with the accompanying drawings, in which like reference numerals designate the same elements.

FIG. 1 is a exemplary functional block diagram of an image processing device in accordance with the invention;

FIG. 2 is a block diagram of a specific arrangement of components of the image processing device of FIG. 1;

FIG. 3 is a flowchart of the steps of an image processing method performed by the image processing device of FIG. 1 of in accordance with a further embodiment the invention.

FIG. 4(a) is an exemplary graphical plot of an image stored in input image storage unit 1 of FIG. 1;

FIG. 4(b) is an exemplary graphical plot of a filter process of FIG. 1;

FIG. 4(c) is an exemplary graphical plot of a raster scanning process in accordance with the filter process of FIG. 4(b);

FIG. 5(a) is an exemplary graphical plot of the x component of the filter of FIG. 4(b);

FIG. 5(b) is an exemplary graphical plot of the y component of the filter of FIG. 4(b);

FIG. 6(a) is a exemplary graphical plot of filter process results obtained by the raster scanning process of FIG. 4(c);

FIG. 6(b) is an exemplary graphical plot of an edge image obtained by performing a thinning process on the filter process results of FIG. 6(a);

FIG. 7(a) is an exemplary graphical plot of a thinning process performed on the filter process results of FIG. 6(a);

FIG. 7(b) is an exemplary graphical plot of the thinning process performed on an x component of the edge vector of FIG. 6(a);

FIG. 7(c) is an exemplary graphical plot of the thinning process being performed on a y component of the edge vector of FIG. 6(a);

FIG. 7(d) is an exemplary graphical plot of the filter process results of 6(a) using a circle template of FIG. 11(a);

FIG. 8 is a flowchart of the steps of a thinning process of FIG. 3;

FIGS. 9(a) and 9(b) are exemplary graphical plots of particular directions of an edge vector used as alternative conditions for the thinning process of FIG. 8;

FIG. 10 is an exemplary diagram of the relationship between a template and voting planes in accordance with the invention.

FIGS. 11(a), 11(b), 11(c), and 11(d) are exemplary diagrams of templates that are favorable for detecting a face or eye region;

FIG. 11(e) is an exemplary diagram of a voting process in accordance with the invention;

FIG. 12(a) is an exemplary diagram of an edge image produced when the thinning process of FIG. 8 is applied to the image of FIG. 16(a);

FIG. 12(b) is an exemplary diagram of an edge image produced when the voting process of FIG. 11(e) is applied to the image of FIG. 16(a);

FIGS. 13(a), 13(b), and 13(c) are exemplary tables representing ring filters used to extract maxima points in accordance with the invention;

FIG. 14(a) is an exemplary diagram representing the scanning of a ring filter of FIGS. 13(a), 13(b), and 13(c) in accordance with the invention;

FIG. 14(b) is an exemplary diagram of an evaluation plane in accordance with the invention;

FIGS. 15(a) and 15(b) are exemplary graphical plots of distributions of vote values obtained by using the ring filters of FIGS. 13(a), 13(b), and 13(c) in accordance with the invention;

FIG. 16(a) is an exemplary diagram of an edge image in accordance with the prior art Sobel filter system;

FIG. 16(b) is an exemplary diagram of a voting process in accordance with the prior art Sobel filter system.

### DETAILED DESCRIPTION OF THE EXEMPLARY EMBODIMENTS

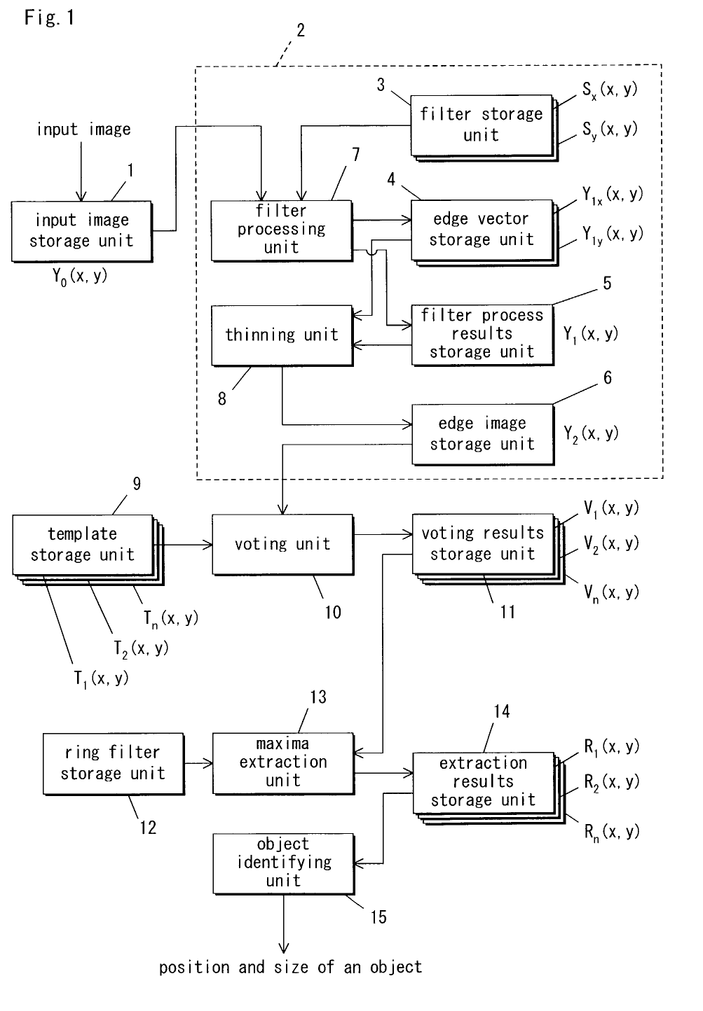

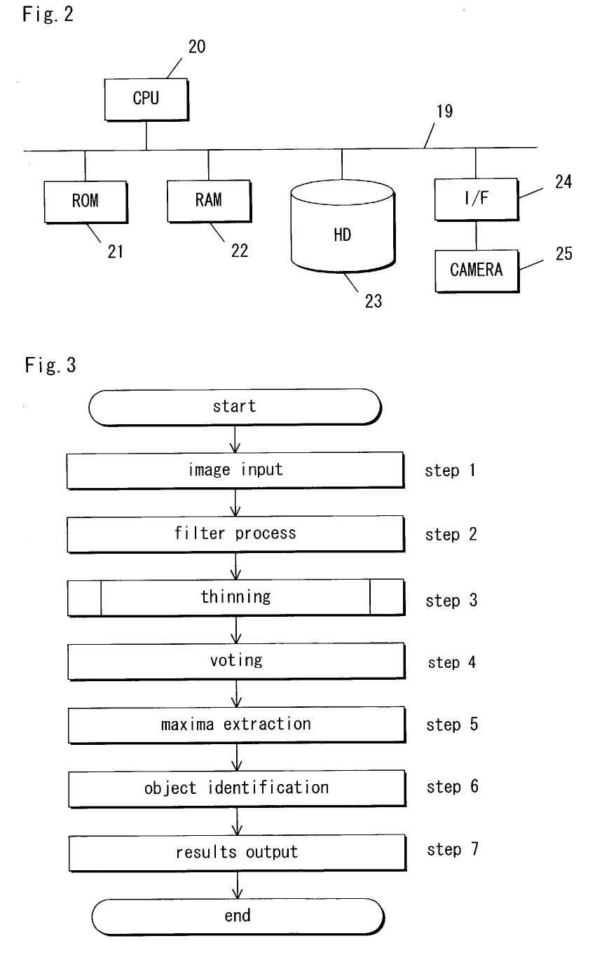

FIG. 1 is a functional block diagram of an image processing device in accordance with the invention. FIG. 2 is a block diagram of a specific arrangement of components of the image processing device of FIG. 1. FIG. 3 is a flowchart of the steps of the image processing method of in accordance the invention.

In accordance with the invention, at a first stage, at step 1, an image is input, shown in FIG. 3. Then, at step 2, a filter process is applied to this image to obtain coarse, thick edges. At step 3, the thick edges are then thinned. At step 4 voting is performed using templates. Points that are maxima are then extracted from the voting results at step 5, the position and size of an object are identified at step 6, and the results are output at step 7.

In accordance the invention, FIG. 2 shows an example of a specific arrangement of the elements shown in FIG. 1. That is, in FIG. 2, a CPU (Central Processing Unit) 20 executes an image processing program, which is stored in a ROM (Read Only Memory) 21 that controls the respective elements shown in FIG. 2 via a bus 19.

In addition to areas for the storage parts 1, 3, 4, 5, 6, 9, 11, 12, and 14 shown in FIG. 1, a temporary memory area required by CPU 20 for performing the processes is secured in a RAM (Random Access Memory) 22 and a hard disk 23.

The respective processing units 7, 8, 10, 13, and 15, which execute the processes in accordance with the invention as shown in FIG. 1, are run by CPU 20 executing the image processing program stored in ROM 21. Also, this program may be stored on hard disk 23 or a CD-ROM or other known form of recording medium.

With further reference to FIG. 2, a camera 25 is connected to an interface 24 to enable real time acquisition of an image that may contain an object. Camera 25 may be one that uses either a CCD or CMOS module. Camera 25 may either be a still camera or a video camera. A camera attached to a portable telephone may also be used.

In FIG. 1, the input image is stored in an input image storage unit 1. For the sake of simplicity, in accordance with this exemplary embodiment, it shall be assumed that the input image is expressed in terms of luminance Y₀(x, y) (8 bits), which is a representative form of expressing brightness. It shall further be assumed that the processes, in accordance with this exemplary embodiment, shall be performed on this luminance Y₀(x, y). However, the luminance Y₀(x, y) may be arranged to have a different form of gradation, or a different expression of brightness other than luminance may be used instead. For example, the input image may be a gray scale image and the luminance Y₀(x, y) may be separated from a color image.

Although the image stored in input image storage unit 1 may be in the form of either a moving image or a still image, when the image is a moving image the aforementioned processes are performed in frame units. When the image is a moving image with a field structure, processes may be performed by combining an odd field and an even field into a single picture.

An image to be stored in input image storage unit 1, can be taken in real time by camera 25 of FIG. 2 or an image that has been taken in the past and has been stored in RAM 22, hard disk 23, or another storage device may be used.

An edge extraction unit 2 inputs the image from input image storage unit 1 and generates an edge image. As shown in FIG. 1, edge extraction unit 2 comprises a filter processing unit 7, which uses a filter that simultaneously performs noise elimination and edge extraction of the edge image, and a thinning unit 8, which performs thinning of the results of the filter process by filter processing unit 7. The filter used by filter processing unit 7 is stored in a filter storage unit 3.

In accordance with contemplated embodiments, this filter is a product of a Gaussian filter function and a unit vector function. Filter processing unit 7 outputs edge vectors in the x-y plane in addition to filter process results produced using the filter in the x and y directions.

Filter processing unit 7 performs a filter process using the filter Sₓ(x, y), S_{y}(x, y) stored in filter storage unit 3. The edge vectors (Y1ₓ(x, y), Y1_{y}(x, y)) are stored in an edge vector storage unit 4. The filter process results Y₁(x, y) are stored in filter process results storage unit 5.

Thinning unit 8 then uses the edge vectors (Y1ₓ(x, y), Y1_{y}(x, y)) and filter process results Y₁(x, y) to extract a local maxima along the line drawn by the filter process results Y₁(x, y), to perform thinning, and to determine the edge parts. In certain embodiments, the filter process is a convolution computation process using the image and the filter.

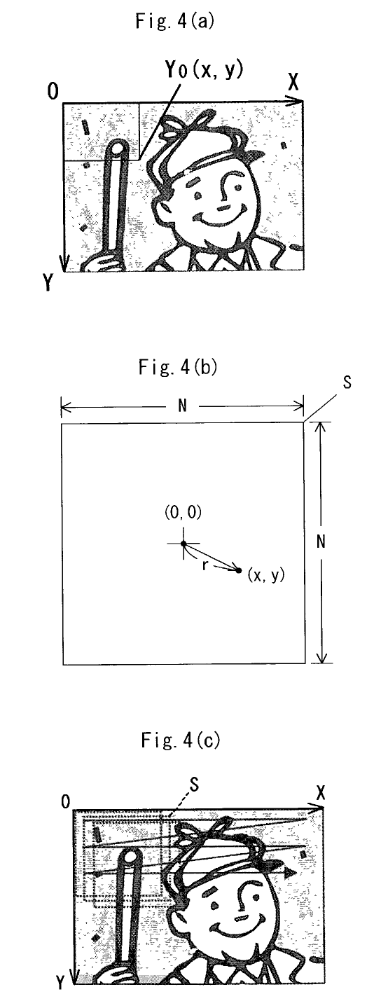

FIG. 4(a) shows an example of an image stored in input image storage unit 1. In accordance with a contemplated embodiments, the filter system is defined as shown in FIG. 4(b). This filter S is N pixels long in each of the vertical and horizontal directions and the center thereof shall be defined as the origin (0, 0).

In certain embodiments, a Gaussian filter expressed in polar coordinates is defined by the following equation, with σ² being the variance and r being the position of a pixel:

$$g ( r ) = \frac{1}{\sqrt{2 π} σ} exp ( - \frac{{r}^{2}}{2 {σ}^{2}} ) \qquad \text{[Equation 1]}$$

In the x-y coordinate system, the above equation will be as follows:

$$g ( x , y ) = \frac{1}{\sqrt{2 π} σ} exp ( - \frac{{x}^{2} + {y}^{2}}{2 {σ}^{2}} ) \qquad \text{[Equation 2]}$$

A unit vector with a magnitude of “1” is expressed as follows:

$$\vec{u} = \frac{\vec{r}}{\vert r \vert} = \frac{( x , y )}{\sqrt{{x}^{2} + {y}^{2}}} = ( \frac{x}{\sqrt{{x}^{2} + {y}^{2}}} , \frac{y}{\sqrt{{x}^{2} + {y}^{2}}} ) = ( {u}_{x} ( x , y ) , {u}_{y} ( x , y ) ) \qquad \text{[Equation 3]}$$

The above filter is a combination of the Gaussian filter function and the unit vector function and has two components, with the component in the x direction being:

$${S}_{x} ( x , y ) = g ( x , y ) \times {u}_{x} ( x , y ) = \frac{x}{\sqrt{2 {πσ}^{2} ( {x}^{2} + {y}^{2} )}} exp ( - \frac{{x}^{2} + {y}^{2}}{2 {σ}^{2}} ) \qquad \text{[Equation 4]}$$

and the component in the y direction being:

$${S}_{y} ( x , y ) = g ( x , y ) \times {u}_{y} ( x , y ) = \frac{y}{\sqrt{2 {πσ}^{2} ( {x}^{2} + {y}^{2} )}} exp ( - \frac{{x}^{2} + {y}^{2}}{2 {σ}^{2}} ) \qquad \text{[Equation 5]}$$

Here, in (Equation 4) and (Equation 5), −N/2≦x≦N/2 and −N/2≦y≦N/2.

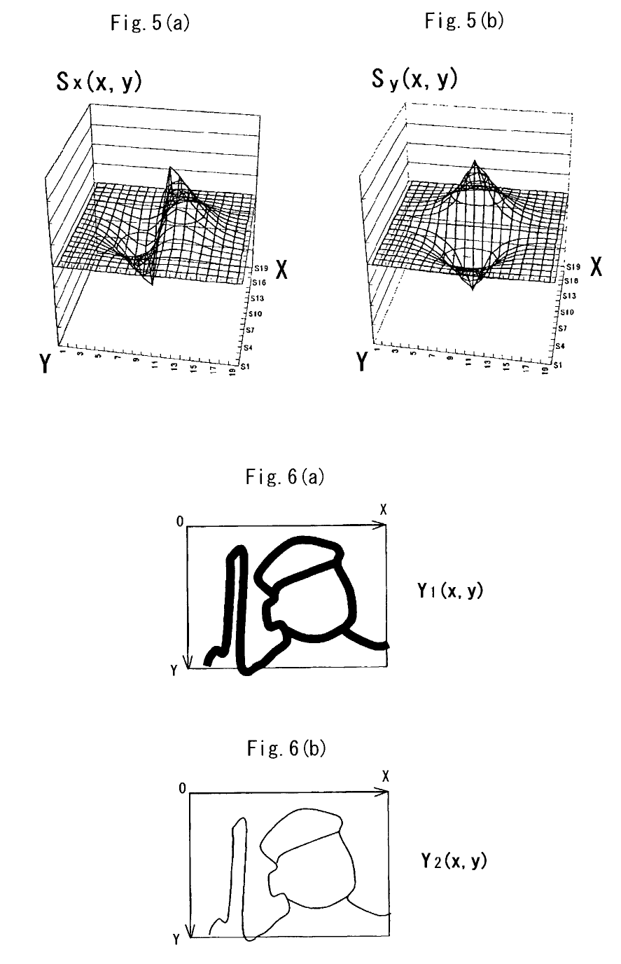

The x-direction filter component is illustrated in FIG. 5(a) and y-direction filter component is illustrated in FIG. 5(b). The filter S shown in FIG. 5 has a 19×19 size. However the filter size may be larger or smaller. A larger filter enables the detection of coarser edges.

In accordance with the filter process, filter S is raster scanned over the image as shown in FIG. 4(c).

As a result of the raster scan, the x component of each edge vector is as follows:

$${Y}_{1 x} ( x , y ) = {\sum }_{l = 0}^{N} {\sum }_{k = 0}^{N} [ {Y}_{0} ( x + k , y + l ) \times {S}_{x} ( k - \frac{N}{2} , l - \frac{N}{2} ) ] \qquad \text{[Equation 6]}$$

and the y component of each edge vector is as follows:

$${Y}_{1 y} ( x , y ) = {\sum }_{l = 0}^{N} {\sum }_{k = 0}^{N} [ {Y}_{0} ( x + k , y + l ) \times {S}_{y} ( k - \frac{N}{2} , l - \frac{N}{2} ) ] \qquad \text{[Equation 7]}$$

Filter processing unit 7 stores these components in edge vector storage unit 4.

A filter process result Y is simply the magnitude of an edge vector and is defined by the following equation:

Y₁(x, y)=\sqrt{Y₁ₓ²(x, y)+Y_{1y}²(x, y)} [Equation 8]

Filter processing unit 7 stores the filter process results calculated by this formula in filter process results storage unit 5. Here, the Gaussian filter eliminates high-frequency noise components. The coarser edges are detected in accordance with the magnitude of σ of the Gaussian filter. In accordance with contemplated embodiments, the filter may be changed in various ways as long as it can be applied regardless of the characteristics of an image, that is, in a hard-and-fast manner and can eliminate noise appropriately.

In general, an image contains edges of various scales. Here the term “scale” is a technical term and has the same meaning as the “scale” (as in “large scale” or “small scale”) as it is ordinarily used. For example, when an image of a certain scene is input into an image processing system, a mountain in the background may have large edges, while a grid of a window of a house in front may have small edges. Also, although the mountain in the background may appear gradual overall, it may be found to have fine uneven structures if viewed closely in detail. In accordance with the contemplated embodiments, the gradual edges of the mountain in the background are viewed at a large scale and the edges of the grid are viewed at a small scale.

The smoothness of the contour of a face, eye, or other object detected in an image is generally predetermined and can be expressed at a fixed scale. Thus, by predefining the scale at which the edges that define the contour of the detected object can best be extracted and other fine edges will not be extracted, it is possible to reliably extract only the contour.

A coarse edge of large scale can be expressed mathematically by a functional argument of low spatial frequency. A fine edge of small scale can be expressed by a functional argument of high spatial frequency. Thus, in order to extract edges of a appropriate scale, edge extraction may be performed after blurring an image properly by applying an appropriate filter to the image. Such a filter may be a band-pass filter. For a fixed bandwidth, the precision of the position of an edge is highest when a Gaussian function is used.

In accordance with the contemplated embodiments, the filter uses a Gaussian function, and has a bandwidth defined by the scale by which contours can be best extracted. This filter is combined with a unit vector in the x direction and y direction. In particular, the scale and bandwidth are related to the size of the filter.

In the prior art the following three processes are performed:

(Process 1) smoothing (the filter size is an empirical value);

(Process 2) edge detection (the filter size is an empirical value); and

(Process 3) elimination of small edges using a threshold value (the threshold value is adjusted for each case).

However, in accordance with the contemplated embodiments of the invention, it is unnecessary to perform all three processes. In particular, by setting the filter size to a size by which contours can be extracted easily, it is possible to extract edges in a single process and in a hard-and-fast manner that is not dependent on the characteristics of image. Thus, the edges are also extracted without having to perform such troublesome processes as adjusting the threshold value based on environmental conditions, surroundings, and the like.

FIG. 6(a) is a graphical plot of the filter process results obtained by the scan shown in FIG. 4(c). A comparison of FIG. 6(a) with FIG. 4(c) clearly shows that unevenness and fine noise are eliminated. Moreover, edges that are thicker than the original contour lines are detected. Thus with these filter process results because the size of filter S is large, the detected edges are extremely thick, despite the fact that fine edges and noise are eliminated, and the coarse edges of contours are detected.

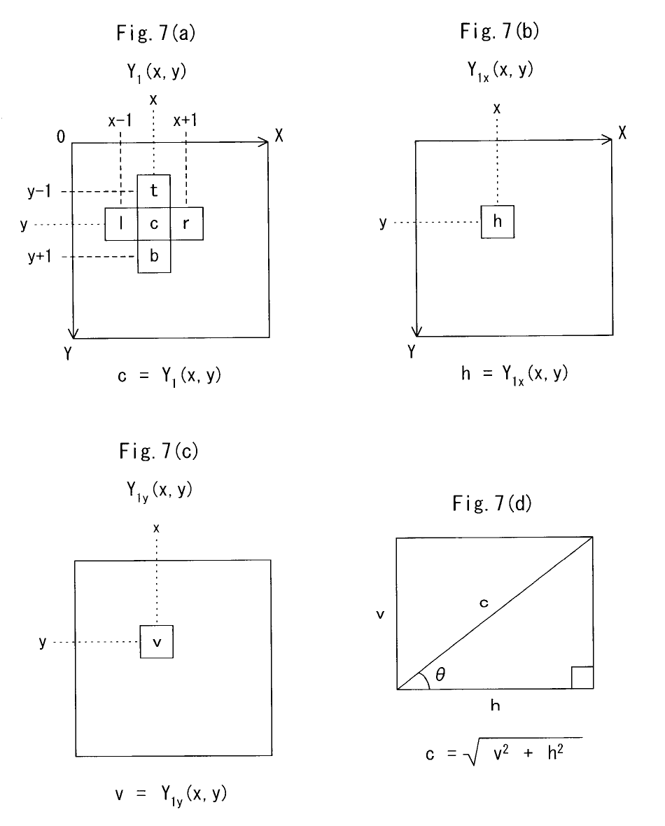

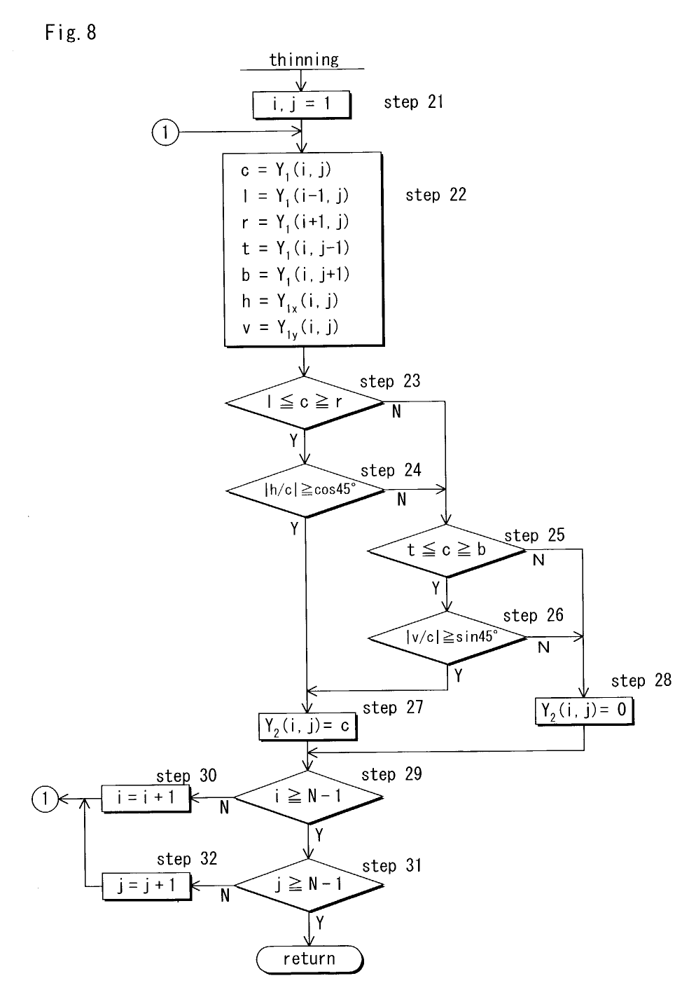

At the next stage, a thinning process is performed by thinning unit 8. That is, thinning unit 8 executes a process that is in accordance with the flowchart shown in FIG. 8 to thin filter process results, as shown in FIG. 6(a), in order to generate an edge image, as shown in FIG. 6(b). Thinning unit 8 thins the filter process results based on the relationship between magnitudes of the filter process results for a target pixel and the magnitudes of the pixels adjacent to this target pixel and on the direction of the edge vector, as shown in FIGS. 7-9.

Prior to starting thinning, the filter process results Y1(x, y) are stored in filter process results storage unit 5 as shown in FIG. 7(a) and edge vectors (Y1ₓ(x, y), Y1_{y}(x, y)) are stored in edge vector storage unit 4.

Here, when the target pixel has the coordinates (x, y) as shown in FIG. 7(a), let c be the filter process result for these coordinates, h be the x component Y1ₓ(x, y) of the edge vector at these coordinates, and v be the y component Y1_{y}(x, y) of the edge vector at the same. Also, let l, r, t, and b be the filter process results of pixels that are adjacent to the target pixel at the left, right, upper, and lower sides. These will be in the geometrical relationship shown in FIG. 7(d).

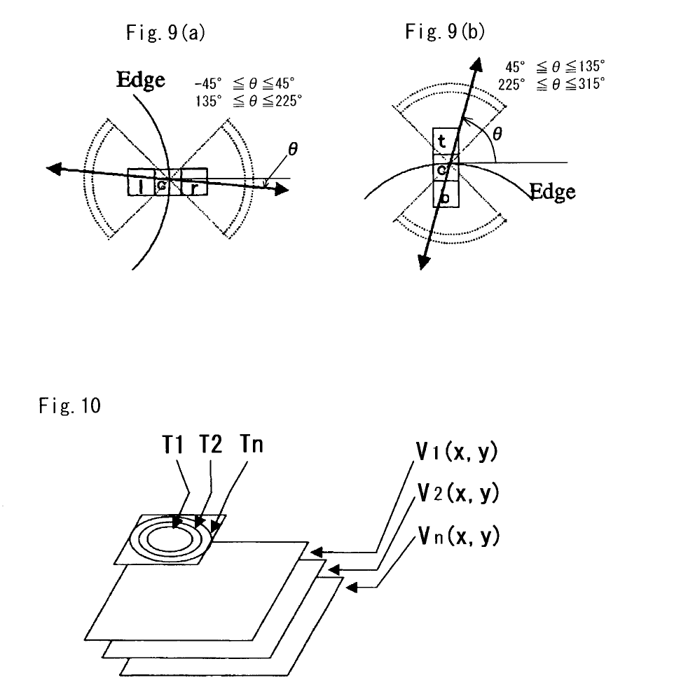

Then, in accordance with the contemplated embodiments, if the direction of the edge vector is as shown in either FIG. 9(a) or FIG. 9(b), c is stored in the edge image Y₂(x, y) of target pixel (x, y) (the target pixel is an edge) and if direction of the edge vector is not as shown in FIG. (a) or FIG. 9(b), 0 is stored in the edge image Y₂(x, y) of target pixel (x, y) (the target pixel is not an edge). Thick edges, as shown in FIG. 6(a), can thereby be converted to sharp edges, as shown in FIG. 6(b).

In FIG. 9(a) the direction of the edge vector is such that the angle θ formed with the x axis is within the range of −45°≦θ≦45° or 135°≦θ≦225° and the relationship, l≦c≧r, holds. In FIG. 9(b) the direction of the edge vector is such that the angle θ formed with the x axis is within the range of 45°≦θ≦135° or 225°≦θ≦315° and the relationship, t≦c≧b holds.

The values of the variables given above are only those of an exemplary embodiment and may be changed in various ways. Thinning can thus be performed by extracting just the ridges of the undulations of the thick edges found in the filter process results. Noise can thereby be restrained and the number of edge points can be reduced prior to voting by voting unit 10.

In accordance with contemplated embodiments, thinning unit 8 performs the process shown in FIG. 8. That is, in step 21, the coordinate counter i for the x direction and the coordinate counter j for the y direction are initialized to 1 and the substitution of values described using FIG. 7 is carried out (step 22).

Then in steps 23-26, thinning unit 8 checks whether or not the condition of either FIG. 9(a) or FIG. 9(b) is satisfied in regard to the coordinates indicated by counters (i, j). If either condition is satisfied, the edge image is set to c for the coordinates indicated by counters (i, j) in step 27 and if not, the edge image is set to 0 in step 28.

Then upon incrementing the counters i and j in steps 29 to step 32, the processes of step 22 onwards are repeated. When these repeated processes have been completed, a thinned edge image will be stored in edge image storage unit 6.

With reference to FIGS. 1, 10, and 11, voting unit 10 uses templates T1, T2, . . . Tn stored in template storage unit 9 to perform voting on the edge image stored in edge image storage unit 6 and generate voting results.

In accordance with contemplated embodiments, as shown in FIG. 10, the templates T₁, T₂, . . . Tₙ stored in template storage unit 9 and the voting results V₁, V₂, . . . Vₙ stored in voting results storage unit 11 are stored based on a classification of a plurality of sizes.

Likewise in FIG. 1, the extraction results R₁, R₂, . . . Rₙ stored in extraction results storage unit 14 are stored based on a classification of a plurality of sizes. Object identifying unit 15 identifies the position and size of an object. Not only the position but also the size of an object can thereby be detected simultaneously.

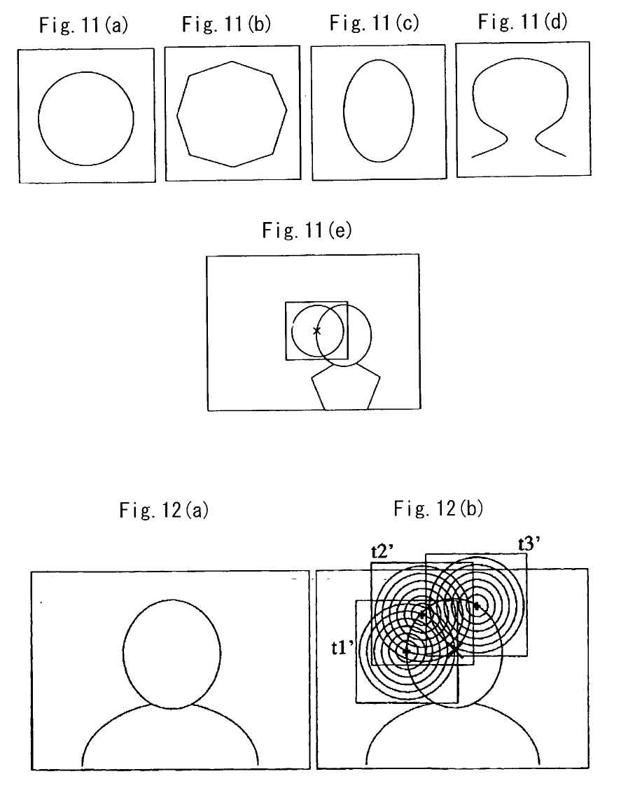

FIGS. 11(a) to (d) show examples of templates that are favorable for detecting a face or eye region. That is, closed lines, such as the circle shown in FIG. 11(a), polygon shown in FIG. 11(b), or ellipse shown in FIG. 11(c) may be used or lines that are opened in the manner of a head and shoulders as in FIG. 11(d) may be used.

As mentioned previously, a template may be a circle, a ring with a width of 1 or more, an ellipse other than a circle, a regular hexagon or other polygon. Using a circle will result in a voting result with a high degree of precision because the distance from the center of the template to all pixels on the shape will always be fixed. With a polygon, though the precision will not be as high as that with a circle, the shape will be simple, enabling the load on the processor to be lightened and the processing speed to be improved.

When the center of a template is found to exist on an edge of the edge image stored in edge image storage unit 6, as shown in FIG. 11(e), voting unit 10 performs voting (addition of a fixed value) on a voting plane of a corresponding size found in voting results storage unit 11.

In the process of increasing the number of votes, the number of votes may be arranged to decrease monotonously instead. In certain embodiments, the initial voting value is set to 0 and the voting plane of a corresponding shape is arranged to increase by one each time a vote is made. Also, although Hough voting was used in this embodiment, a similar voting technique may be used instead.

In accordance with contemplated embodiments, when the thinning is applied to the image of FIG. 16(a), the result will be as shown in FIG. 12(a). When voting is performed on this image, the result will be as shown in FIG. 12(b).

When the image in FIG. 16(a) is input into the Sobel filter excess voting is performed, such as that shown by templates t4 and t5 in FIG. 16(b). However, when the image of FIG. 12(a) is input, because the amount of noise is low, excess voting is not performed, as shown in FIG. 12(b). As a result, excess voting and excess computational processing are eliminated. Thus it is also possible to avoid the difficulties associated with the masking of the vote values of the true face position caused by excess voting.

Thus, according to this embodiment, the results of FIG. 12(a) are an improvement over the prior art results of FIG. 16(a) because the amount of computational processing is reduced and the detection accuracy is improved.

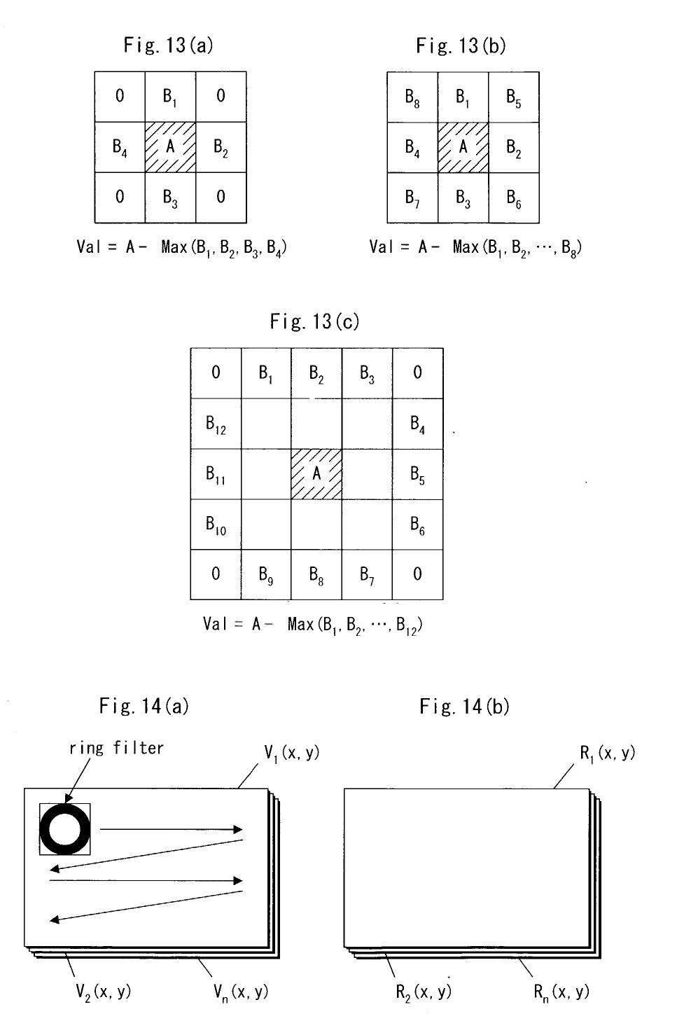

The maxima extraction unit 13 shown in FIGS. 1 and 13 extracts maxima in the voting results that are stored in voting results storage unit 11 to generate extraction results.

In a further embodiment, maxima extraction unit 13 uses a ring filter, which uses the differences between the voting result of a central pixel and the voting results of pixels that surround the central pixel to generate the extraction results and detects voting points. Each of the voting points are local maximums and are isolated from the results of voting.

Ring filters, shown in FIGS. 13(a) to (c), are stored in the ring filter storage unit 12 shown in FIG. 1. Maxima extraction unit 13 scans such a ring filter along each voting plane V₁, V₂, . . . Vₙ in voting results storage unit 11 as shown in FIG. 14(a). Maxima extraction unit 13 also stores ring filter evaluation values Val in the corresponding extraction planes R₁, R₂, . . . Rₙ in extraction results storage unit 14.

The ring filter of FIG. 13(a) has a size of 3×3. The evaluation value Val of the ring filter is obtained by subtracting the greatest value among four pixels B₁, B₂, B₃, and B₄ surrounding a central pixel from the voting value A of the central pixel when the voting plane overlaps with the filter. Also, as shown in FIG. 13(b), the evaluation value Val of the ring filter may be obtained by subtracting the greatest value among eight pixels B1 to B8 surrounding a central pixel from the voting value A of the central pixel when the voting plane overlaps with the filter. Furthermore, the ring filter may be a size other than 3×3 as shown in FIG. 13(c).

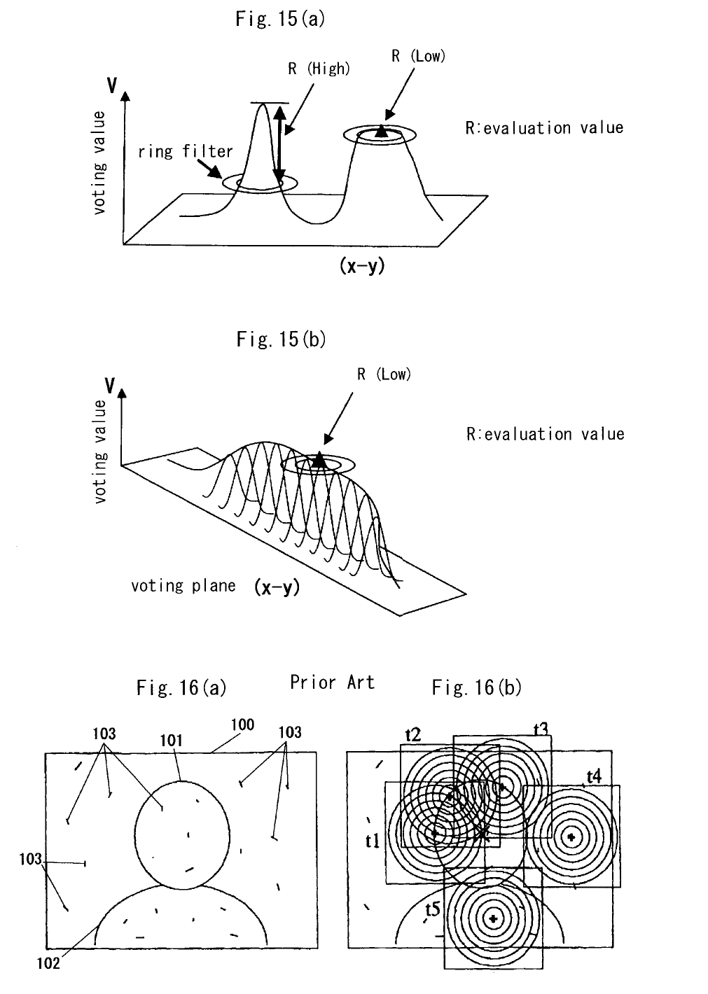

When a distribution of voting values, such as shown in FIG. 15(a), is obtained as a result of using such a ring filter, the evaluation value R high for a point for which the voting value of the central pixel A is both a local maximum and an isolated voting value (e.g., the steep peak at the left side of FIG. 15(a).)

Conversely, when a point has a high voting value but the surroundings have similar high values, such that the point is not isolated (e.g., the right side of FIG. 15(a)) the evaluation value R is low.

The evaluation value R is also low in the case where the components of high voting value extend sideways as with the ridge shown in FIG. 15(b).

Other conventional methods that use a simple fixed threshold value and do not look at undulations of the voting plane cannot detect steep changes. However, the use of a maxima extraction unit 13, in accordance with the contemplated embodiment, enables even steep changes to be captured and is suited for narrowing down face region candidates or eye region candidates.

The object identifying unit 15 in FIG. 1, also identifies the position and size of an object based on the extraction results (the respective extraction planes) stored in extraction results storage unit 14.

In particular, object identifying unit 15 uses the coordinates on the extraction plane having the maximum evaluation value among the evaluation values R of the respective extraction planes as the position of the object and uses the size of the template associated with this plane as the size of the object (which, for example, is expressed as a radius).

A “recording medium that stores a program in a manner enabling reading by a computer” as defined in this Specification includes systems in which the program is dispersed among and distributed over a plurality of recording media. In systems where elements of the functions are performed by various processes or threads (DLL, OCX, ActiveX, and the like (including trademarks of Microsoft Corp.)), the above phrase includes systems in which parts of the program relevant to the functions are not stored in a recording medium, regardless of whether or not the program resides on operating system.

Although an example of a stand-alone type system is shown in FIG. 1, the system may also take on the form of a client/server system. That is, instead of locating all elements appearing in this Specification in a single terminal, one terminal may be a client and all or part of the elements may exist on a server or network to which the terminal can connect.

Also, the server side may have most of the elements of FIG. 1 and the client side may have for example just a WWW browser. In this case, program data is normally held by the server and is basically distributed to a client via a network. When the necessary data resides on the server side, the “recording medium” is the storage device of the server. When necessary data resides on the client side, the “recording medium” is the storage device of the client.

Furthermore, this “program” includes, in addition to an application that has been compiled and converted into machine language, the following configurations: a program that exists as an intermediate code to be interpreted by an abovementioned process or thread; a “recording medium,” in which at least the resources and the source code are stored and a compiler and linker that can generate a machine language application from these resources and source code; a “recording medium,” in which at least the resources and the source code are stored and an interpreter is used that can generate an intermediate code application from these resources and source code; and other suitable configurations.

In accordance with the contemplated embodiments of the present invention, the following is achieved:

Edges are detected at a high speed and in real time with a processing capability of the level of a today's personal computers because noise is restrained and edge points are decreased prior to performing voting.

A person is detected with stability even in cases where a camera is not in a fixed system, the person is not moving much, the background is moving, and other cases where stable edge detection cannot be performed using inter-frame differences because still image edge detection is used instead of frame differences for edge detection.

The number of edge points is reduced and the processing prior to voting is thus excellent because fine edges are eliminated and edges of strong unevenness are converted to gradual, simple edges by the edge extraction unit.

Certain embodiments are suited for detection of a face, eye, and the like because only parts that are not just high in voting value but increase steeply are detected.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An image processing device, comprising:
an edge extraction means for inputting an image to generate an edge image;
a voting means for voting on the edge image with templates to generate voting results;
a maxima extraction means for extracting a maxima among the voting results to generate extraction results; and
an object identifying means for identifying a position of an object based on the extraction results.

2. The image processing device as set forth in claim 1, wherein said edge extraction means has a filter processing means using a filter that simultaneously performs noise elimination and edge extraction of the edge image.

3. The image processing device as set forth in claim 2, wherein said edge extraction means has a thinning means for thinning filter process results of said filter processing means.

4. The image processing device as set forth in claim 2, wherein said filter is a product of a Gaussian filter and a unit vector.

5. The image processing device as set forth in claim 2, wherein said filter processing means outputs filter process results and edge vectors within an x-y plane and said edge vectors comprise an x-direction filter and a y-direction filter.

6. The image processing device as set forth in claim 3, wherein said thinning means thins the filter process results based on a relationship between a magnitude of the filter process results for a target pixel and a magnitude of pixels adjacent to the target pixel and the directions of the edge vectors.

7. The image processing device as set forth in claim 1, wherein said maxima extraction means generates extraction results based on differences between a voting result of a central pixel and a voting result of pixels in areas surrounding the central pixel.

8. The image processing device as set forth in claim 7, wherein said maxima extraction means generates extraction results using a ring filter that determines the differences between the voting results of central pixel and the voting results of the pixels in the areas surrounding the central pixel.

9. The image processing device as set forth in claim 1, wherein said templates, voting results, and extraction results are stored based on a classification of a plurality of sizes, and said object identifying means identifies the position and size of an object.

10. The image processing device as set forth in claim 1, wherein said object is selected from a group consisting of: a face of a human and an eye region of a human.

11. An image processing method comprising the steps of:
inputting an image to generate an edge image;
voting on the edge image with templates to generate voting results;
extracting a maxima among the voting results to generate extraction results; and
identifying the position of an object based on an extraction result.

12. The image processing method as set forth in claim 11, wherein the step for extracting the maxima further comprising the step of:
using a filter that simultaneously performs noise elimination and edge extraction of the image.

13. The image processing method as set forth in claim 12, wherein the step of extracting the maxima further comprising the step of:
thinning filter process results of the filter that simultaneously performs noise elimination and edge extraction of the image.

14. The image processing method as set forth in claim 12, wherein said filter is a product of a Gaussian filter and a unit vector.

15. The image processing method as set forth in claim 12, wherein the step for using the filter further comprising the step of:
outputting filter process results and edge vectors within an x-y plane with an x-direction filter and a y-direction filter.

16. The image processing method as set forth in claim 13, wherein the step of thinning the filter process results is conducted such that the filter process results are thinned based on a relationship between a magnitude of filter process results for a target pixel and pixels adjacent to the target pixel and based on a magnitude of the directions of the edge vectors.

17. The image processing method as set forth in claim 11, wherein the step for extracting the maxima is conducted such that extraction results are generated based on differences between the voting result of a central pixel and the voting results of pixels in areas surrounding the central pixel.

18. The image processing method as set forth in claim 17, wherein the step for extracting the maxima is conducted such that extraction results are generated with a ring filter that determines differences between the voting results of a central pixel and the voting results of pixels in areas surrounding the central pixel.

19. The image processing method as set forth in claim 11, wherein said templates, voting results, and extraction results are stored based on a classification of a plurality of sizes; and
wherein the step of identifying the position of an object is conducted such that a position and a size of an object are identified.

20. The image processing method as set forth in claim 11, wherein said object is a face of a human or an eye region of a human.

21. A recording medium storing, in a manner enabling data retrieval by a computer, an image processing program, comprising the steps of:
inputting an image to generate an edge image;
voting on the edge image with templates to generate voting results;
extracting a maxima among the voting results to generate extraction results; and
identifying a position of an object is identified based on the extraction result.
